(19) United States
(12) Patent Application Publication
(10) Pub. No.: US 2023/0074061 A1
(43) Pub. Date: Mar. 9, 2023

(54) ISOLATION, CONCENTRATION AND DETECTION OF SMALL PARTICLES

(71) Applicant: Imagine TF, LLC, Campbell, CA (US)

(72) Inventor: Brian Edward Richardson, Los Gatos, CA (US)

(21) Appl. No.: 17/467,565

(22) Filed: Sep. 7, 2021

(51) Int. Cl. B01D 29/90; B01D 29/60

(52) U.S. Cl. CPC B01D 29/90; B01D 29/60; G01N 15/10

(57) ABSTRACT

A filtering device generally constructed from two panels is disclosed herein. The device may be used for the isolation, concentration, and detection of particles with particular chosen characteristics. A first panel, an etched or molded filter panel, includes an array of V-shaped channels wherein the walls of the V-shaped channels have spacer pads and offset walls that create filtering pores when the filter panel is mated to a flat surface of a second panel. The use of semiconductor processing equipment provides incredible accuracy as well as the ability to construct extremely small features.

### FIELD OF THE DISCLOSURE

The present disclosure is for a device useful for isolating, concentrating, and detecting particles in a fluid utilizing filter panels. More specifically, the device provides a plurality of filter panels aligned in series to isolate a particular sized particle from larger and smaller particles. The arrangement also allows for the concentration of particles within a fluid for ease of detection of the isolated particles.

### SUMMARY

Various embodiments of the present disclosure teach a filtering device generally constructed from two panels. The device may be used for the isolation, concentration, and detection of particles with particular chosen characteristics. A first panel, an etched or molded filter panel, includes an array of V-shaped channels wherein the walls of the V-shaped channels have spacer pads and offset walls that create filtering pores when the filter panel is mated to a flat surface of a second panel.

The use of semiconductor processing equipment provides incredible accuracy as well as the ability to construct extremely small features.

### BRIEF DESCRIPTION OF THE DRAWINGS

The accompanying drawings, in which like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a perspective view of a filtration device shown without a cover plate.

FIG. 2 is a perspective closeup view of the filter shown in FIG. 1, also shown without a cover plate.

FIG. 3 is a closer view of a section of FIG. 2.

FIG. 4 is a view of the filter section shown in FIG. 2 from a different perspective.

FIGS. 5A and 5B are sectional views of the filter shown in FIG. 4. FIG. 5A shows the section without a cover as in the previous FIG. 5B includes the covers.

FIGS. 6A and 6B are closeup views of a small section of FIG. 5B and include a particle and light rays.

FIG. 7 is a perspective view of a serial embodiment of the invention shown without a cover plate.

FIG. 8 is a perspective view of a backwash embodiment of the invention shown without a cover plate.

FIG. 9 is a closeup section view of the pore area of a device utilizing pressure.

FIG. 10 is the same section view shown in FIG. 5B with the addition of an elastic spacer.

FIG. 11 is a perspective view of a recirculation device.

FIG. 12 is a flow chart of the operation of the filter shown in FIG. 11.

FIG. 13 is a closeup perspective view of a ribbed embodiment of the invention.

FIG. 14 is perspective view the cover associated with the embodiment shown in FIG. 13. The cover is shown upside down in relation to other perspective views described above.

FIG. 15 shows an alternate configuration of the filter walls.

### DETAILED DESCRIPTION

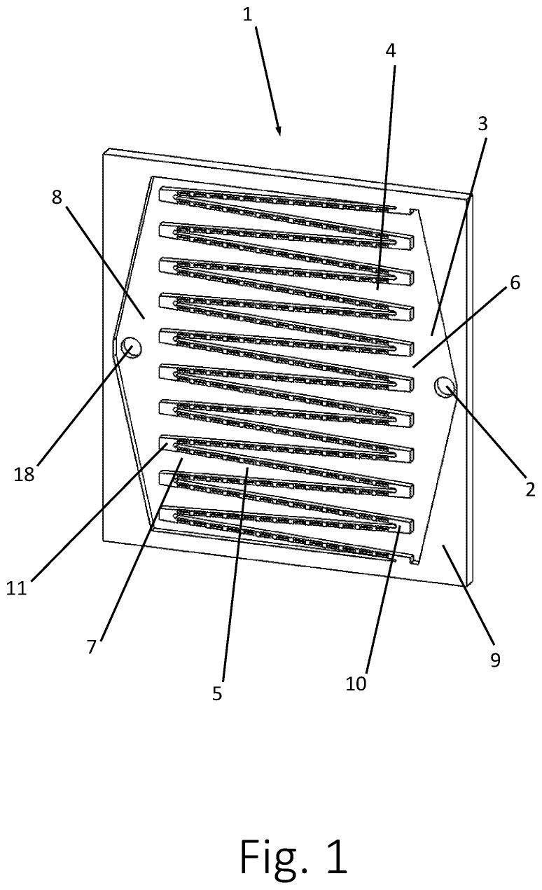

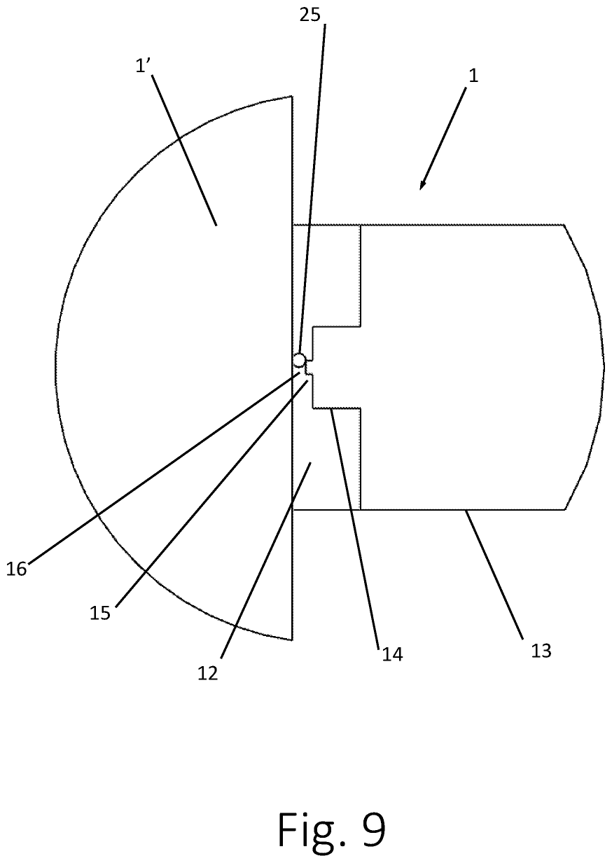

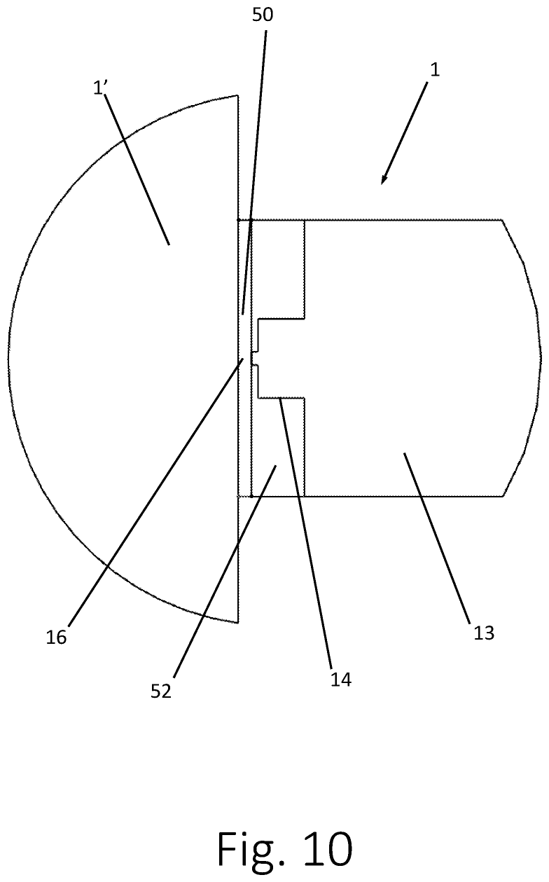

FIG. 1 is a perspective view of a filter device. The filter device is constructed by mating a filter panel 1 to a cover panel 1′ (see e.g. FIGS. 9 and 10). In preferred embodiments of the invention, the cover panel 1′ has a flat surface that mates to the filter panel 1. In order to more clearly illustrate the details of the filter panel 1, the cover panel 1′ is not shown in FIG. 1.

A fluid, either a liquid or a gas, enters the device from the backside of the filter panel 1, and flows to the frontside of the filter panel 1 through an inlet port 2. The fluid flows from the inlet port 2 and is distributed to a plurality of inlet V-shaped channels 4 via inlet plenum 3.

A large number of the inlet V-shaped channels 4 are arranged next to one another in a parallel flow configuration. The inlet V-shaped channels 4 are in fluid communication with each other so that the fluid is constrained to flow down the inlet V-shaped channels 4. The inlet V-shaped channels are joined at the inlet pad ends 10.

The inlet plenum 3 is constructed to deliver fluid to each of the inlet V-shaped channels 4 at generally the same flow rate. Pore walls 5 extend from the base surface 6 of the filter panel 1 to form the walls of the V-shaped channels 4. Top surfaces of the pore walls 5 contact the cover panel 1′. The end pads 10 also extend from the base surface 6 and extend to and mate with the cover plate 1′.

A border plane 9 also mates with the cover panel 1′. The border plane 9 directs the flow of fluid from the inlet plenum 2 to the inlet V-shaped channels 4. On the opposite side of the pore walls 5, the outlet V-shaped channels 7 are formed and connect to an outlet plenum 8. The fluid flow path continues from the outlet plenum 8 to the outlet port 18.

Either the inlet port 2 or the outlet port 18 or both elements can be configured on the cover panel 1′ for manufacturing convenience. Further, the inlet port 2 and the outlet port 18 can extend to the sides of the filter panels from their respective plenums.

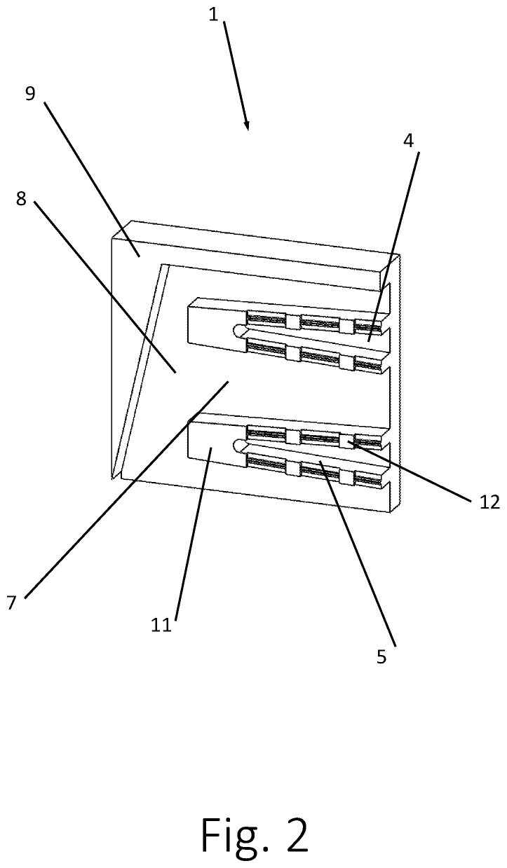

A closeup of the upper section of the outlet area can be seen in FIG. 2. FIG. 2 shows the border plane 9, the outlet end pads 11, and the spacer pads 12 in greater detail. The upper surfaces of the border plane 9, the outlet end pads 11, and the spacer pads 12 are planar so that they mate with the inside flat surface of the cover plate 1′. The spacer pads 12 are generally spaced equally at the pore walls 5 along the wall from the inlet end pads 10 to the outlet end pads 11.

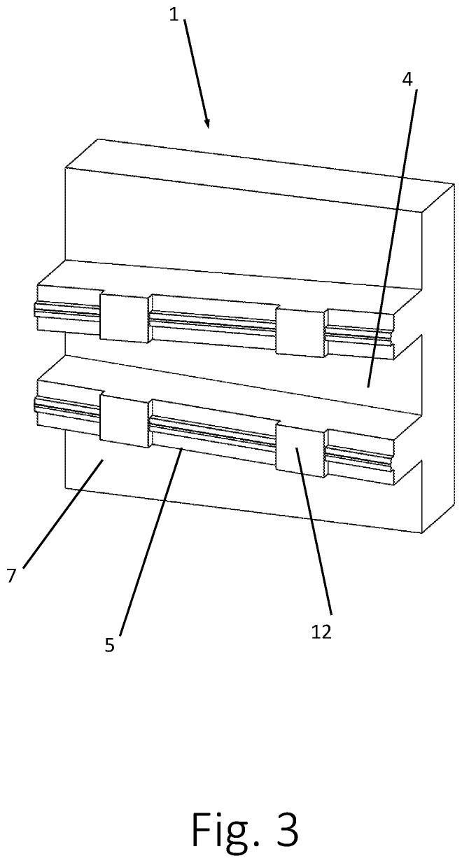

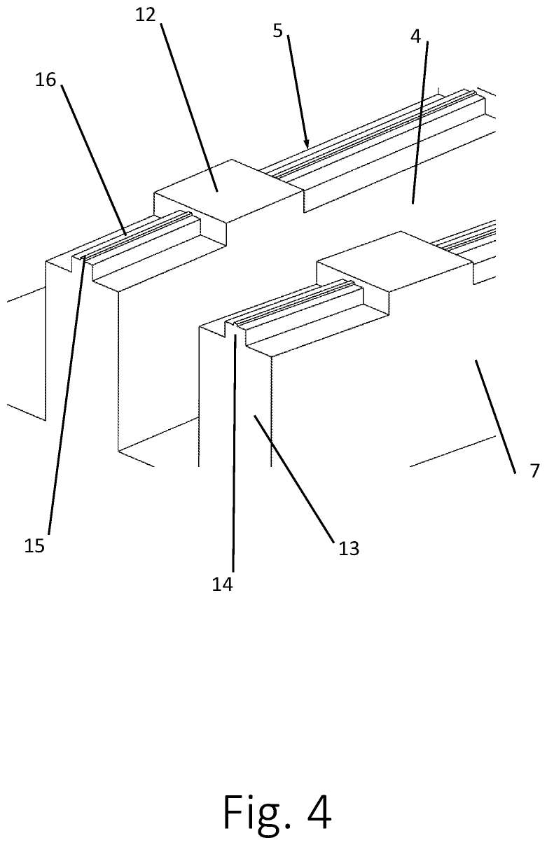

A still further magnified view of the pore walls 5 is shown in FIG. 3. FIG. 4 shows the same features as illustrated in FIG. 3 but from a different perspective. FIG. 4 shows the relationship of the spacer pads 12 to the pore wall 5 and attendant components, a wide pore wall 13, a smaller (shorter) medium pore wall 14, and a still smaller (shorter yet) narrow pore wall 15. The wide pore walls 13 define wide pores, the medium pore walls 14 define medium size pores, and the narrow pore walls 15 define the most narrow pores.

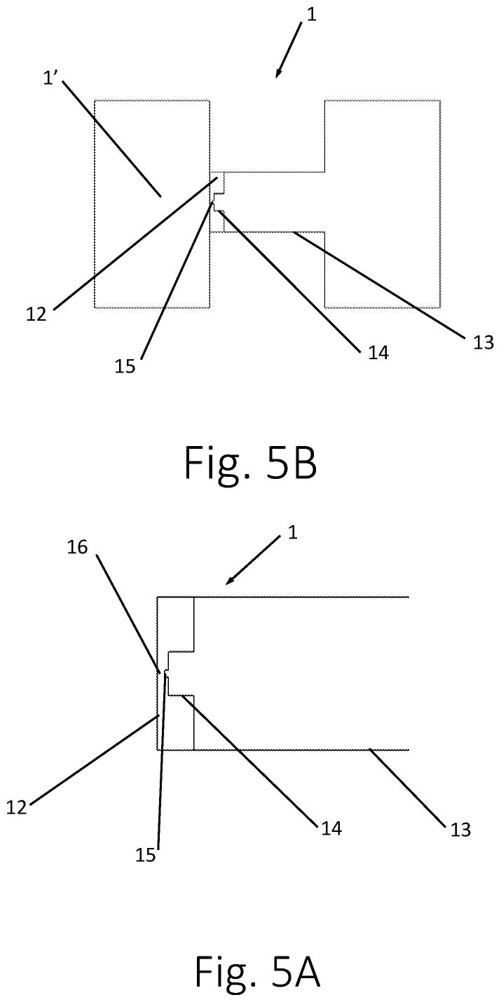

FIGS. 5A and 5B show cross sections of the pore walls with and without the cover panel 1′. The height of the narrow pore wall 15 is slightly lower than the height of the spacer pads 12 and the end pads 11. This difference in height creates a pore 16 that restricts particles larger than the pore 16 from flow from the inlet channels 4 to the outlet channels 7.

The dimensions of the stepped wall from wide and tall to narrow and short is chosen to be optimal for manufacturing, durability, and flow characteristics of a given application. For durability reasons the stepped wall is preferably a single narrow wall that is relatively tall. For a filter device in which small pores are desired, in the range of tens of nanometers, the dimensions of the walls might be as follows: narrow wall 15 of 20 nm wide by 20 nm tall; medium wall 14 of 200 nm wide by 200 nm tall; and wide pore wall 13 10 um wide by 20 um tall. For a filter device with moderate sized pores, in the range of hundreds of nanometers, the sizes of the walls might be: narrow wall 15 200 nm wide wall by 200 nm tall; medium wall 14 4 um wide by 4 um tall; and wide pore wall 13 20 um wide by 50 um tall.

By utilizing pores constructed with wide, medium, and narrow walls, the flow rate of the filter device is increased as compared to a filter device utilizing only a single wall with the same size pores. The flow rate of a narrow wall 200 nm wide would be 200 times greater than that of a 20 um wide wall. This is based on the equation for flow rate in a channel where the flow rate has an inverse linear relationship to the width of the wall (commonly referred to as channel length in reference to the general equation for flow rate).

As mentioned above, semiconductor processing equipment is one option to manufacture the filter panels. With semiconductor processing equipment the pore size can be controlled within the size of one atom or molecule. Atomic layer deposition (ALD) is a process in which one atomic layer of material is deposited at a time during processing. This enables the construction of filter devices with pores of one atom accuracy. ALD would typically be used to create the spacer pads 12 that define the pore size in the filter panel 1.

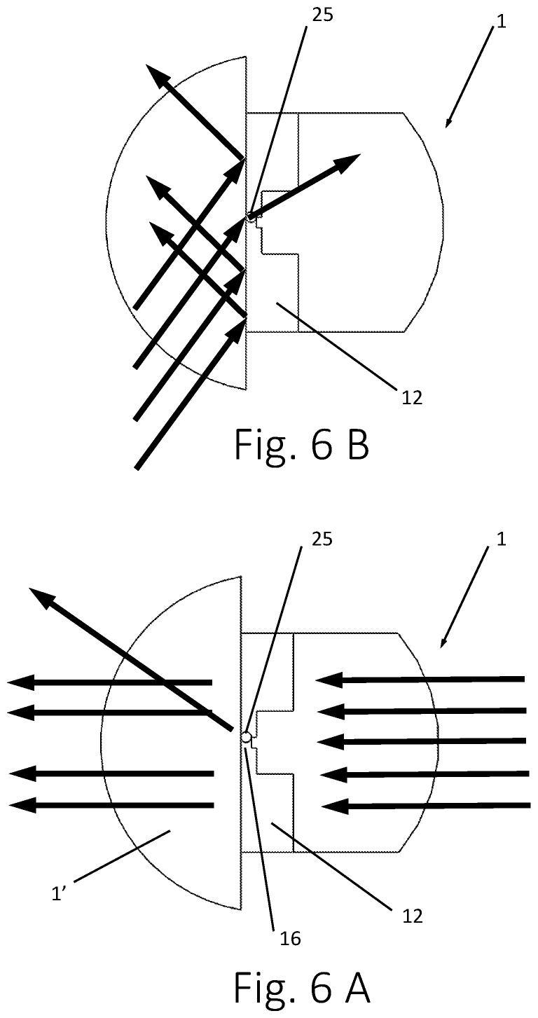

Referring to FIGS. 6A and 6B, the filter panel 1 is shown with a particle 25 retained at the pore 16 formed between the cover panel 1′ and the top of the narrow pore wall 15. Particles larger than pore 16 are collected at this location, while smaller particles pass through the pore 16.

In many cases it is desirable to know if a particle has been retained in a filter device. A light source and a detector can readily be deployed to detect particles within a filter panel. Detection can be accomplished by directing a light source to the pore 16. The light is either allowed to pass uninterrupted in the absence of a particle, or the path of the light is disrupted by the presence of a particle 25. The degree of the disruption of the light can be equated to the number and/or size of particles collected at the pore 16. One skilled in the art of light sources and detectors could devise many ways to illuminate the pores and detect the disruption of the light by particles. At least one of the filter panels would need to be optically transparent to use light as the detection method.

FIG. 6A is a schematic depiction of a light source directing light to the pore 16 and related areas of the filter panel 1 from the bottom side of the filter panel 1. Light not deflected by a particle would generally pass through the cover panel 1′ uninterrupted. Light impinging on a particle 25 would in most cases be deflected to alter its direction. A detector or detectors located to detect these deflected rays would enable detection of the presence of a particle.

FIG. 6B shows an alternate configuration employing a light source to detect a particle 25 trapped in the pore 16. In FIG. 6B, the light source is illuminating the cover panel 1′ from a side of the cover. Light is injected into the transparent cover panel 1′ at an angle to create reflections within the internal walls of the cover panel 1′. This internal reflection is commonly described as total internal reflection (TIR). The TIR light travels along the inside walls of the cover panel 1′ with high efficiency. When a ray of light impacts the wall where there is a particle in contact with the wall, the TIR light is disrupted. This disruption in transmission would in most cases allow light to escape the internal reflection within the cover panel 1′. A detector could be used to monitor the escaped light, therefore indicating the presence of trapped particles 25.

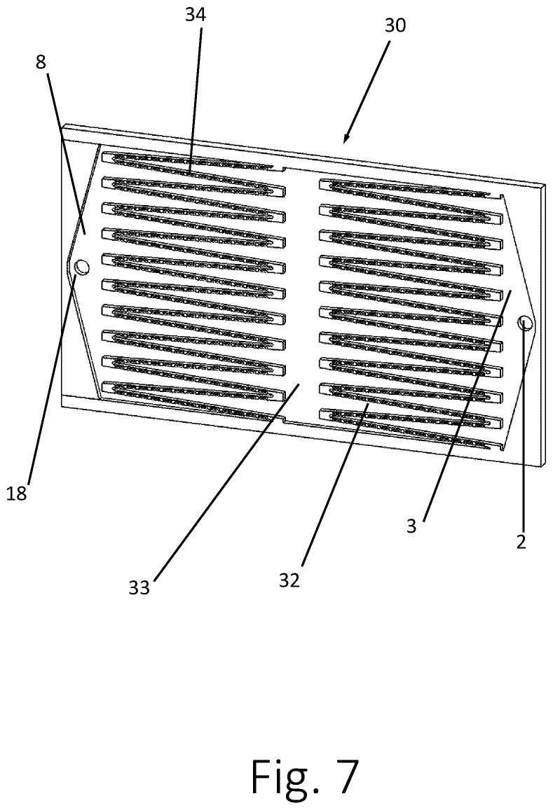

FIG. 7 shows a different configuration for a filter panel 30. In this configuration, a first filter panel 32 is installed in series with a second filter panel 34. It should be noted that more than two panels can be utilized in series. Two panels are illustrated for ease of explanation. The first filter panel 32 is linked to the second filter panel 34 via an intermediate plenum 33. It should be noted that additional plenums and ports could be deployed to connect the first filter 32 to the second filter 34. The first filter 32 and the second filter 34 could also be located farther from one another and connected by tubing or piping.

The pores in the first filter 32 in a multiple filter configuration are slightly larger than the pores in the second filter 34 and successive filters. When a fluid flows through both of these filter panels 32, 34, particles within a given size range are collected at the first filter 32, while particles smaller than the first filter 32 pores but still within the specified particle size range are collected at the pores of the second filter 34.

For example, if the size range of particles to be extracted is 99 nm to 101 nm (the current understanding of the diameter of SARS-CoV-2 virus), the first filter 32 pores would be 101 nm in size, thereby retaining all particles larger than 101 nm. The fluid solution that passed through the first filter 32 would contain particles smaller than 101 nm. The pores in the last filter panel in the sequence, in this example the second filter panel 34, would be fabricated at 99 nm in size. This would result in the collection of particles larger than 99 nm at the second filter 34. Both particles smaller than 99 nm and the carrier fluid in the solution would pass through the second filter panel 34 and exit the outlet port 18. Only particles from 99 nm to 101 nm are collected in the filter panel 34.

Note that with ALD processing, the pores can be manufactured to be almost exactly 101 nm. The pores can be as accurate within the diameter of one atom or molecule. In the case of silicon dioxide, SiO₂ the molecular diameter is 0.15 nm. This accuracy and precision combined with the detection methods discussed above forms a powerful tool to isolate the then identify a specific range size of particle.

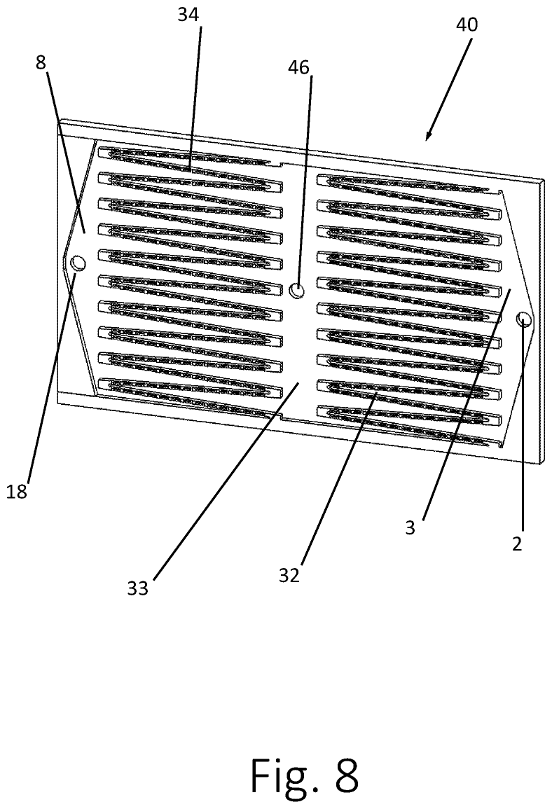

FIG. 8 shows an embodiment with a slightly different configuration. In various embodiments utilizing this configuration, a backwash port 46 is added between the first filter panel 32 and the second filter panel 34 to create a backwash filter panel 40. With the addition of the backwash port 46, particles retained by the second filter 34 can be backwashed. A backwash solution is introduced into the outlet port 18. By restricting flow to exit the inlet port 2 and only allowing the backwashed fluid to exit the backwash port 46, particles retained in the second filter panel 34 are carried out of the filtering device with the backwash solution though the backwash port 46.

The backwashed solution exiting the backwash port 46 contains particles with a narrow size range that have been collected in the second filter 34. Because of the compact nature of the V-shaped channels and the plenums, only a small amount of backwash fluid is required. Many liters of fluid can be run through the backwash filter panel 40. The first filter panel 32 would collect a portion of the particles in an initial solution. The size of the first filter 32 may need to be large in overall size if the solution inlet to the device contains a high percentage of relatively large particles. In most typical cases, the second filter 34 does not need to be as large as might be required for the first filter panel 32 because the second filter panel 34 is only collecting a relatively small number of particles. Thus, only a small amount of backwash fluid is needed to clear the particles from the second filter 34 and out the backwash port 46. The backwashed solution can be observed by a light scattering detector or a more complex instrument to further evaluate the sample's contents.

The ratio of the initial sample fluid volume to the backwash fluidic volume can be very large—hundreds or even thousands to one. This is highly desirable when trying to detect a small amount of a pathogen in a large volume of sample fluid. SARS-CoV-2 is one particular particle of interest. Both isolation and concentration of the virus is desired. The invention disclosed herein can accomplish both with a high degree of accuracy and consistency.

It should also be mentioned that inexpensive polymer copies of a semiconductor master of the filter device can be created. This is a common practice in the fabrication of microfluidic devices. Metal copies are also an option.

FIG. 9 illustrates the use of the disclosed technology to differentiate particles of varying elasticities. By referencing a known fluid flow rate, particles of the same size but with differing elasticities can be isolated. A ridged particle 25 that is slightly larger than the pore size of the fluid panel 1 would require more force to deflect and force it though the pore than a particle with lesser elasticity. The force on the particle is a function of the viscosity and the flow rate of the fluid. By incrementally increasing the flow rate or viscosity of the fluid in the device, the force on the particle can be incrementally increased. At some point, the particle 25 will pass through the pore. Therefore, like sized particles with different elasticities can be discriminated by increasing the pressure and/or viscosity of the fluid.

With extremely small particles the electrical charge on the surface of the particle or the surface of the filter may affect filtration. A charge interaction between the particle and the filter can be overcome by increasing the force on the particle and can be used to filter particles, in part as a function of their charge.

An example of the need to separate particles by both size and elasticity would be the separation of circulating tumor cells (CTC's) from a blood sample. CTC's and white blood cells overlap in size, but they differ greatly in elasticity. By deploying a filter with elasticity discrimination, CTC's can be more effectively separated from a blood sample than simply selecting by size.

FIG. 10 illustrates another method of controlling the pore size of the device. The short spacer pad 52 may be varied, and an elastic spacer pad 50 added to adjust the effective pad height. To reach a pore size equivalent to that disclosed in the above discussion, the combined height of the short spacer pad 52 and the elastic spacer pad 50 can be made equal to the previously disclosed spacer pad 12. By adding the elastic spacer pad 50 the overall height of the spacer stack can be varied, thereby varying the pore size of the device. In exemplary embodiments, increasing the force applied to the elastic spacer pads 50 decreases the pore size of the filter device. Force can be applied to the spacer pads in many ways. One skilled in the art of force mechanisms could readily construct many adequate pore size variation solutions. Examples of suitable force application devices would be a mechanical lead screw and by using an external pressure created by an external fluid.

Adjustable pore size can be used not only to filter different sized particles within one filter device, but also to flush particles captured by the pores. Captured particles can be released from the pores by reducing the force on the elastic spacer pads 52. The released particles can be collected for further analysis or detection. The particles can also be released so that the filter can expel all particles and be “cleaned” for reuse.

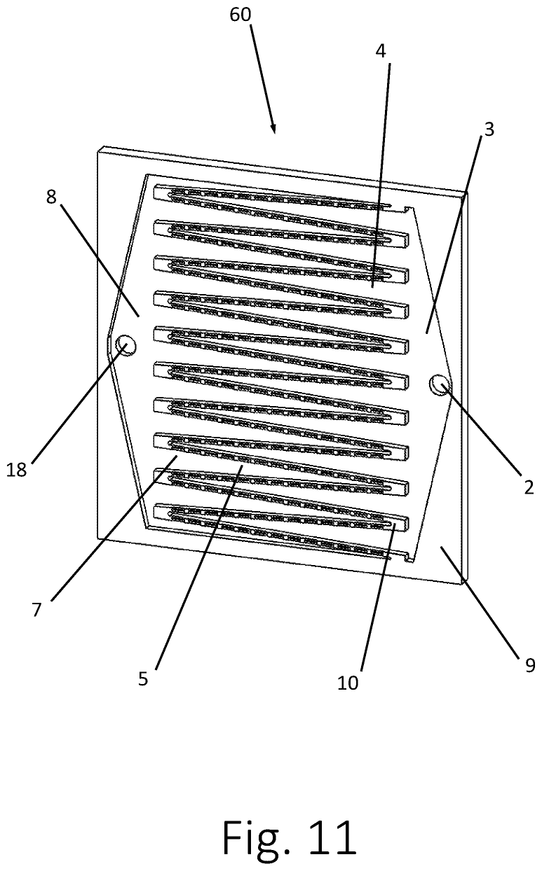

FIG. 11 shows a single stage adjustable filter panel 60 that utilizes elastic spacers as discussed above. Due to the elastic spacers, the adjustable filter panel 60 has an adjustable pore size.

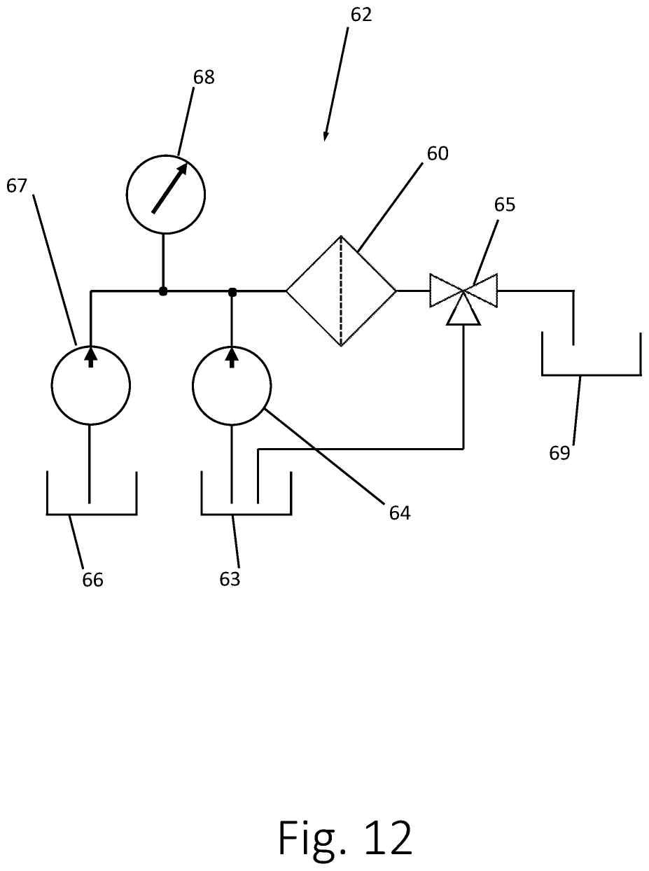

FIG. 12 is a flow chart 62 illustrating how the adjustable filter 60 can be used to separate and identify particles of different sizes and elasticities. A sample volume reservoir 63 contains a sample fluid with a range of particles of different elasticities and possibly sizes. A sample pump 64 is used to deliver the sample to only the adjustable filter 60. Preferably, the adjustable filter panel 60 is adjusted to only retain the largest of particles of interest in the sample. The remaining smaller particles exit the adjustable filter 60 with the accompanying fluid to a valve 65. The valve 65 directs the fluid and particles back to the sample reservoir 63. When all of the large particles have been retained in the filter 60, the sample pump 64 is turned off and valve 65 is switched to direct the fluid to a sample reservoir 69. A buffer solution, generally of the same type as the sample fluid but without the particles of interest, is delivered from the buffer reservoir 66 to the adjustable filter 60 via buffer pump 67.

A pressure gage 68 can be deployed to monitor the fluid pressure. The flow rate and pressure would initially be low. As the flow rate is increased, highly elastic particles retained by the adjustable filter 60 would be expelled from the pores of the filter panel 60. The valve 65 directs the output of the adjustable filter 60 to the sample reservoir 69. The contents of the sample reservoir 69 can be evaluated by a local detector, or transferred to another device for analysis.

The adjustable pores of the adjustable filter 60 could be reduced in size to remove smaller particles from the sample remaining in the sample reservoir. And again, pressure from increased flow can be used to further separate the particles by their elasticity.

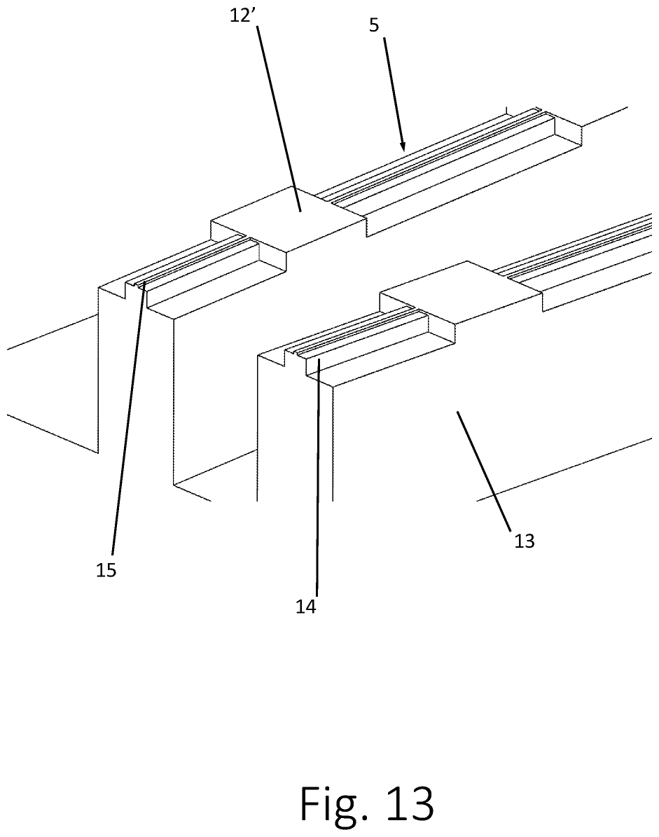

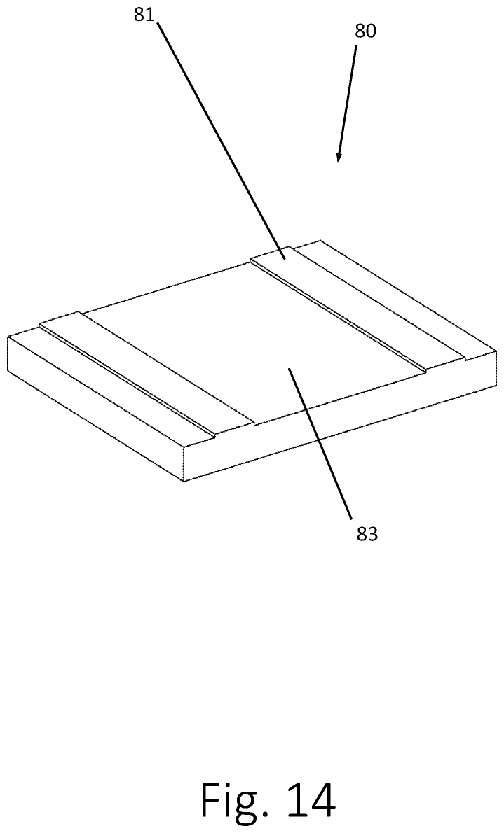

FIGS. 13 and 14 show a different type of spacer pads 12′. The top of the spacer pads 12′ are in the same plane as the top of the narrow wall 15. In this case, a cover panel 80 would have cover spacer pads 81 that would accomplish the task of the spacer pads 12 described above. The cover spacer pads 81 are fabricated to match the shape and size of the spacer pads 12, or they can be elongated elements. Ribs are preferred over square geometry in that they only need to be aligned with the spacer pads 12′ in one direction rather than two. With either configuration, the cover spacer pads 81 would determine the pore size of the filter. It should be noted that either pad configuration can be included with all embodiments of the invention.

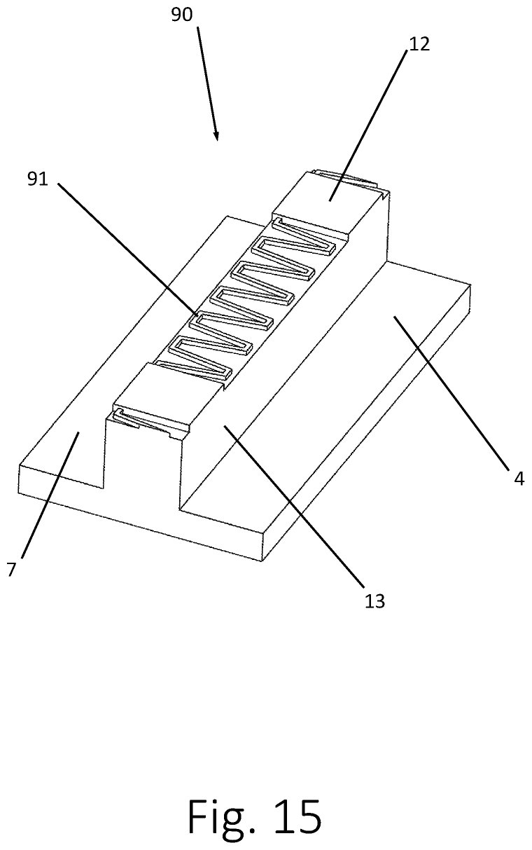

FIG. 15 shows an alternate configuration of a filter panel 90. In this configuration, the walls defining the narrow pores are generally W-shaped walls 91. The W-shaped walls 91 are deployed to increase the overall pore area for a given installation of a filter panel 90. The height of the pore is chosen depending on the parameters of the application being considered. The length of the pore is greater when the W-shaped geometry is deployed over linear type pores as disclosed above.

The fluids processed by the filter panels discussed above are generally liquids. It should be noted that the disclosed filter panels can be used with gases as well as with fluids. Further, a combination of liquids and gases could be processed. A significant combined liquid/gas application of significance would be using air to backwash particles from filters such as those disclosed above relative to FIG. 8. If a liquid is backwashed with air, the resultant liquid volume of the backwashed fluid would be smaller than if a liquid fluid were used for backwashing.

Another significant liquid/gas example would be the isolation of a particle from large quantities of air. By backwashing particles collected from air with water, the isolated particles would be retained within a liquid. Liquid is often the preferred type of fluid for analysis with analytical instruments.

The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. Exemplary embodiments were chosen and described in order to best explain the principles of the present disclosure and its practical application, and to enable others of ordinary skill in the art to understand the present disclosure for various embodiments with various modifications as are suited to the particular use contemplated.

The terminology used herein is for the purpose of describing particular embodiments only and is not intended to be limiting of the technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the Figures are merely schematic representations of the present disclosure. As such, some of the components may have been distorted from their actual scale for pictorial clarity.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A filtration device, comprising:
a filter panel comprising an inlet port, an inlet plenum, walls forming fluid flow channels, an outlet plenum, and an outlet port; and
a second panel that covers fluid flow areas of the filter panel to enclose the fluid flow channels; and wherein
pores of predetermined pore size are formed by constructing gaps between the second panel and the walls forming the fluid flow channels.

2. The filtration device of claim 1, wherein:
spacers are positioned between the walls and the second panel to establish and maintain the predetermined pore size.

3. The filtration device of claim 1, wherein:
the fluid flow channels are V-shaped.

4. The filtration device of claim 1, wherein:
the walls forming the fluid flow channels are constructed with varying heights, the heights of each wall defining a pore size formed by the wall.

5. The filtration device of claim 1, wherein:
the walls forming the fluid flow channels are constructed in a W-shaped configuration.

6. The filtration device of claim 1, wherein:
elastic spacers are positioned between the walls and the second panel to establish and maintain the predetermined pore size, the pore size being variable and controlled by pressure applied to the elastic spacers.

7. The filtration device of claim 1, wherein:
a flow rate of fluid into the device is varied to determine elasticity of isolated particles.

8. The filtration device of claim 1, wherein:
a viscosity of fluid flowing into the device is varied to determine elasticity of isolated particles.

9. The filtration device of claim 1, wherein:
a light detection mechanism is used to identify isolated particles.

10. The filtration device of claim 9, wherein:
the light detection mechanism utilizes total internal reflection.

11. A filtration device, comprising:
a first filter panel comprising an inlet port, an inlet plenum, walls forming fluid flow channels, an outlet plenum, and an outlet port; a
a second filter panel arranged in series with the first filter panel and including an inlet port, an inlet plenum, walls forming fluid flow channels, an outlet plenum, and an outlet port;
a cover panel that covers fluid flow areas of the filter panels to enclose the fluid flow channels; and wherein
pores of predetermined pore size are formed by constructing gaps between the cover panel and the walls forming the fluid flow channels, the pores in the first filter panel being of a different size as compared to the pores in the second filter panel.

12. The filtration device of claim 1, wherein:
spacers are positioned between the walls and the cover panel to establish and maintain the predetermined pore size.

13. The filtration device of claim 1, wherein:
the fluid flow channels are V-shaped.

14. The filtration device of claim 1, wherein:
the walls forming the fluid flow channels are constructed with varying heights, the heights of each wall defining a pore size formed by the wall.

15. The filtration device of claim 1, wherein:
the walls forming the fluid flow channels are constructed in a W-shaped configuration.

16. The filtration device of claim 1, wherein:
elastic spacers are positioned between the walls and the second panel to establish and maintain the predetermined pore size, the pore size being variable and controlled by pressure applied to the elastic spacers.

17. The filtration device of claim 1, wherein:
a flow rate of fluid into the device is varied to determine elasticity of isolated particles.

18. The filtration device of claim 1, wherein:
a viscosity of fluid flowing into the device is varied to determine elasticity of isolated particles.

19. The filtration device of claim 1, wherein:
a light detection mechanism is used to identify isolated particles.

20. The filtration device of claim 19, wherein:
the light detection mechanism utilizes total internal reflection.
